(19) United States
(12) Patent Application Publication
(10) Pub. No.: US 2025/0262750 A1
(43) Pub. Date: Aug. 21, 2025

(54) MOBILE OPERATING ROBOT

(71) Applicant: Beijing Youzhuju Network Technology Co., Ltd., Beijing (CN)

(72) Inventors: Guangzeng Chen, Beijing (CN); Yifeng Li, Beijing (CN); Tao Kong, Beijing (CN); Taozheng Yang, Beijing (CN); Minzhao Zhu, Beijing (CN)

(21) Appl. No.: 19/033,461

(22) Filed: Jan. 21, 2025

(30) Foreign Application Priority Data
Feb. 18, 2024 (CN) 202410181774.2

(51) Int. Cl. B25J 5/00; B25J 19/00; B25J 19/02

(52) U.S. Cl. CPC B25J 5/007; B25J 19/002; B25J 19/023

(57) ABSTRACT

The embodiments of the disclosure provide a mobile operating robot including a movable platform, a height adjustment assembly, a displacement assembly and an end effector, wherein the height adjustment assembly is disposed on the movable platform; a fixed end of the displacement assembly is coupled to the height adjustment assembly; a free end of the displacement assembly is capable of performing spatial displacement relative to the fixed end; and the end effector is coupled to the free end of the displacement assembly for executing a predetermined operation.

### CROSS REFERENCE TO RELATED APPLICATION(S)

This application claims priority to Chinese Application No. 202410181774.2 filed on Feb. 18, 2024, the disclosure of which is incorporated herein by reference in its entirety.

### FIELD

Embodiments of the present disclosure generally relate to the technical field of robots, and in particular to a mobile operating robot.

### BACKGROUND

With an improvement of intelligent level, patrol robots have been widely used in fields of warehousing, machine rooms, industrial manufacturing, public safety and the like, and delivery robots and the like also appear in places such as hotels and restaurants. The patrol robots are intelligent automation devices designed for performing inspection and monitoring tasks, which can realize accurate positioning and obstacle avoidance of a complex environment, and move according to a predetermined route or a dynamic planning path. The patrol robots are usually equipped with a high-definition camera and various inspection instruments, which may collect and analyze image data in real time, and identify potential faults, abnormal conditions or potential safety hazards. The delivery robots may transport express, take-out, and other items to a specified position, and remind a user to manually take out. In a related art, the functions of the robots are relatively professional and focused, and are mainly limited to patrol or transportation. That is, the robots do not have functions such as item picking up, processing or directly controlling other systems, cannot perform physical operations or interaction tasks, and cannot meet usage requirements of scenarios such as home or warehousing.

SUMMARY

A purpose of the embodiments of the present disclosure is to provide a mobile operating robot to at least solve the above problems and other potential problems.

The embodiments of the present disclosure provide a mobile operating robot, including:
a movable platform;
a height adjustment assembly disposed on the movable platform;
a displacement assembly including a fixed end and a free end, wherein the fixed end is coupled to the height adjustment assembly to move with the height adjustment assembly, and the free end is capable of performing spatial displacement relative to the fixed end; and
an end effector coupled to the free end of the displacement assembly for performing a predetermined operation.

In some embodiments, the displacement assembly includes:
a multi-joint operating arm comprising two opposite ends, an end of the multi-joint operating arm is the fixed end, and the other end of the multi-joint operating arm is the free end.

In some embodiments, the height adjustment assembly includes:
a supporting part disposed on the movable platform; and
a moving part supported by the supporting part and coupled to the fixed end of the displacement assembly, wherein the moving part is capable of moving up and down relative to the supporting part to adjust a relative height between the displacement assembly and the movable platform.

In some embodiments, the mobile operating robot further includes:
a camera assembly coupled to at least one of the movable platform and the height adjustment assembly.

In some embodiments, the mobile operating robot further includes:
an angle adjustment assembly disposed at a top of the supporting part and coupled to the camera assembly, wherein the angle adjustment assembly is configured to adjust at least one of a horizontal view angle and a pitching view angle of the camera assembly.

In some embodiments, the mobile operating robot further includes:
a housing sleeved on an outer side of the height adjustment assembly and coupled to the movable platform; wherein a side wall of the housing is provided with an opening extending vertically, the displacement assembly penetrates through the opening, the fixed end is located on an inner side of the housing, and the free end is located on an outer side of the housing.

In some embodiments, the housing includes a body part and a base part below the body part, a cross-sectional area of the body part in a horizontal direction is adapted to a cross-sectional area of the height adjustment assembly in the horizontal direction, the body part is connected to the base part, and the base part is connected to a top edge of the movable platform.

In some embodiments, the mobile operating robot further includes:
a counterweight component disposed on the movable platform, wherein the counterweight component is configured to balance a bending torque when the displacement assembly and the end effector extend out.

In some embodiments, the fixed end of the displacement assembly is detachably connected to the height adjustment assembly.

In some embodiments, the end effector is detachably connected to the free end of the displacement assembly.

In some embodiments, the movable platform includes a two-wheel differential chassis.

In embodiments of the present disclosure, the mobile operating robot includes the movable platform, the height adjustment assembly, the displacement assembly, and the end effector, the height adjustment assembly and the displacement assembly are mounted on the movable platform, the displacement assembly moves with the height adjustment assembly, the free end of the displacement assembly is capable of performing spatial displacement relative to the fixed end, and the end effector is coupled to the free end of the displacement assembly for executing the predetermined operation. When the mobile operating robot operates, the movable platform moves according to a predetermined route or a dynamic planning path, and simultaneously carries the height adjustment assembly, the displacement assembly and the end effector to synchronously move, a spatial position and a spatial angle of the free end of the displacement assembly are adjusted, and then the end effector is moved to a target position. The end executor may perform a predetermined operation, and may perform a physical operation or an interactive task, and may meet usage requirements of scenarios such as home or warehousing.

It should be understood that the content described in the summary is not intended to limit key features or important features of the embodiments of the present disclosure, nor is it intended to limit a scope of the present disclosure. Other features of the present disclosure will become readily understood from following description.

### BRIEF DESCRIPTION OF DRAWINGS

The above and other features, advantages, and aspects of various embodiments of the present disclosure will become more apparent from following detailed description taken in conjunction with drawings. In the drawings, the same or similar reference numbers refer to the same or similar elements, wherein:

FIG. 1 illustrates a schematic structural diagram of a mobile operating robot according to an embodiment of the present disclosure, wherein a housing is removed;

FIG. 2 illustrates a schematic structural diagram of the mobile operating robot shown in FIG. 1, wherein a housing is shown;

FIG. 3 illustrates a schematic structural diagram of a displacement assembly and a movable platform;

FIG. 4 illustrates a schematic structural diagram of a matching relationship between a supporting part and a moving part of a height adjustment assembly;

FIG. 5 illustrates a schematic structural diagram of a connection relationship between a camera assembly and an angle adjustment assembly.

### DESCRIPTION OF REFERENCE NUMERALS

10a movable platform;
20 displacement assembly; 21 fixed end; 22 free end;
30 end executor;
40 height adjustment assembly; 41 supporting part; 42 moving part; 43 lead screw; 44 lead screw motor; 45 lead screw controller; 46 transformer; 47 drag chain;
50 camera assembly;
60 angle adjustment assembly; 61 pan-tilt control unit; 62 head rotating component; 63 connecting flange; 64 head pitching component;
70 housing; 71 opening; 72 body part; 73 base part;
80 counterweight component;
91 central control unit; 92 voltage converter; 93 intelligent sensing unit.

### DETAILED DESCRIPTION

In order to make purposes, technical solutions and advantages of the present disclosure clearer, the present disclosure will be further described in detail below with reference to the drawings.

It should be noted that, unless otherwise defined, technical terms or scientific terms used in the embodiments of the present disclosure should be of ordinary meanings understood by those skilled in the art to which the present disclosure belongs. The terms “first”, “second” and similar terms used in the embodiments of the present disclosure do not represent any order, quantity, or importance, but are merely used to distinguish different components. The terms “comprising” or “comprising” and the like means that an element or object appearing in front of the term encompasses elements or objects appearing behind the term and equivalents thereof, without excluding other elements or objects. The terms “connected” or “connected” and the like are not limited to physical or mechanical connections, but may include electrical connections, whether direct or indirect. “Upper”, “lower”, “left”, “right” and the like are only used to represent relative position relationships, and when an absolute position of described object changes, a relative position relationship may also change accordingly.

It may be understood that, before the technical solutions disclosed in the embodiments of the present disclosure are used, a type, a usage scope, a usage scenario and the like of personal information related to the present disclosure should be notified to user in an appropriate manner according to relevant laws and regulations and obtain an authorization of the user.

In order to make the technical solutions of the present disclosure clearer and easy to understand, the mobile operating robot provided by the embodiments of the present disclosure will be described in detail below with reference to the drawings.

As described in the background section, the functions of the current robots are relatively professional and focused, and are mainly limited to patrol or transportation. That is, the robots do not have an operation function such as item picking up, processing, or directly controlling other systems, cannot perform a physical operation or an interaction task, and cannot meet the usage requirements of the scenarios such as home or warehousing.

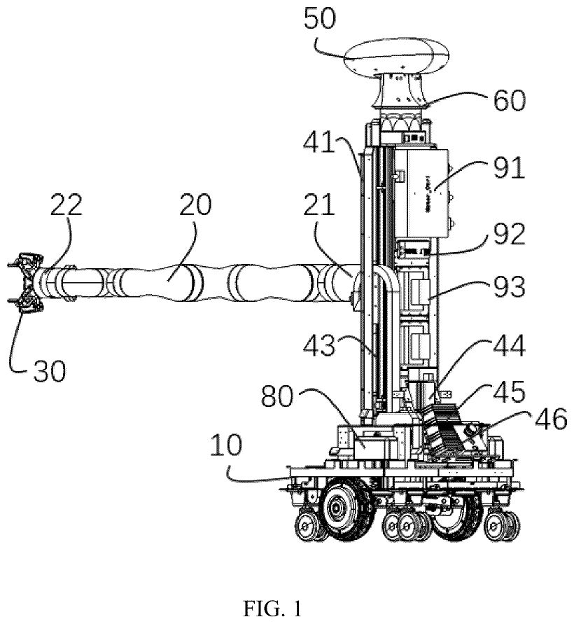

In view of this, the embodiments of the present disclosure provide a mobile operating robot, referring to FIG. 1 to FIG. 5, the mobile operating robot includes a movable platform 10, a displacement assembly 20, an end effector 30, and a height adjustment assembly 40.

The movable platform 10 is a key component of a robot system, which is responsible for a movement and a positioning function of the robot, ensuring that the robot may efficiently and accurately move to a predetermined position in a complex environment. A structural form of the movable platform 10 directly affects maneuverability and flexibility of the robot and the adaptability to different scenarios. The movable platform 10 includes a wheel platform, a crawler-type platform, a multi-foot/bionic platform, a track platform (for a specific application) or a flight platform and the like, and the movable platform 10 may be determined according to actual usage requirements.

The wheel type platform includes two-wheel differential driving, three-wheel or four-wheel independent driving and other forms, which use an electric motor to drive the wheels to perform linear walking and turning. The wheel platform is suitable for fast moving on flat ground, and has high driving speed and low energy consumption. A two-wheel differential driving platform includes a two-wheel type differential chassis and a plurality of universal wheels mounted at a bottom of the chassis, and the two-wheel type differential chassis coordinate a speed difference of two driving wheels through a differential mechanism to realize flexible motion control. Under control of the differential mechanism, left and right wheels are allowed to rotate at different speeds. When the robot turns, an inner wheel must be slower than an outer wheel to accommodate changes in turn radius. The differential mechanism automatically adjusts rotating speeds of the wheels on two sides through an internal gear set structure, so that the robot can smoothly and stably turn. Each driving wheel is driven by a separate driving source, such as a motor, and is connected by a differential mechanism. In this way, the robot not only can travel in a straight line but also can turn in place or perform flexible large-radius turning. For some two-wheel differential chassis with suspension systems, even if the ground is uneven, at least one driving wheel can be ensured to maintain good contact with the ground, thereby maintaining good traction and stability. Robots used in indoor navigation, item delivery, and other scenarios often adopt the two-wheel differential chassis designs to move freely in narrow channels.

The crawler-type platforms imitate tank track design, and provide better terrain adaptability and traction, and are especially suitable for complex, uneven or soft ground environments.

The multi-foot/bionic platform simulates a biological walking mode, such as six-foot, eight-foot and the like, and can stably move in a complex and rugged environment, and can span a large obstacle.

The track platform may adapt a specially designed track wheel system for specific applications to ensure that the robot can safely and accurately travel along a track.

The flight platform (for example, an unmanned aerial vehicle) may perform tasks in air with a rotor wing or a fixed wing technology, which is not limited by terrain, but it needs to consider endurance, control and safety problems.

A plurality of sensors and control systems, such as an inertial measurement unit (IMU), an odometer, a GPS, a visual navigation system, and the like, are generally integrated on the movable platform 10, and are configured to acquire robot position and posture information in real time, and control autonomous navigation and obstacle avoidance of the robot through a motion planning algorithm. In addition, the movable platform 10 also needs to have sufficient load capacity to carry various inspection devices and tools to perform tasks.

The height adjustment assembly 40 is disposed on the movable platform 10 and may move synchronously with the movable platform 10.

The movement operating robot further includes at least one displacement assembly 20, that is, the displacement assembly 20 may be provided with one or more as needed, and the displacement assembly 20 is a core structure for performing an actual displacement operation. The displacement assembly 20 includes a fixed end 21 coupled to the height adjustment assembly 40 and a free end 22 that may move with the height adjustment assembly 40. The fixed end 21 is relatively fixed in position and plays a role in support and reference. The free end 22 is a movable part whose range of motion is determined by a design of the displacement assembly 20.

In some embodiments, a mounting base is disposed on the height adjustment assembly 40 or other stabilizing structures on the height adjustment assembly 40, the fixing end 21 is connected to the mounting base, and at this time, positioning, mounting and dismounting of the fixing end 21 of the displacement assembly 20 are relatively convenient. Meanwhile, a circuit interface may be disposed on the mounting base, the circuit interface is matched with a circuit interface of the displacement assembly 20, and when the fixed end 21 is mechanically connected with the mounting base, a circuit connection is also completed.

The fixed end 21 of the displacement assembly 20 is coupled to the height adjustment assembly 40, that is, the fixed end 21 of the displacement assembly 20 is tightly combined with a fixed point or frame of the height adjustment assembly 40 in a mechanical, electrical, hydraulic or magnetic manner and the like, the fixed end 21 and the height adjustment assembly 40 move synchronously with the movable platform 10, and the movable platform 10 may transport the displacement assembly 20 to a predetermined position. A torque or power of the displacement assembly 20 can be effectively transmitted to the free end 22 to enable the free end 22 to perform translational or rotational motion in a predetermined manner.

An action of the displacement assembly 20 is driven by commands issued by a control system (such as an industrial personal computer). For example, after receiving an electrical signal sent by the industrial personal computer, a lead screw motor 44 may rotate and drive a lead screw 43, a gear or other transmission mechanism, so that the free end 22 of the displacement assembly 20 may perform spatial displacement (such as linear or curvilinear motion) in a designed path. The displacement assembly 20 may be driven by a hydraulic cylinder, a servo motor and the like, and a transmission component of the displacement assembly 20 can be formed by combining a connecting rod, a curved arm, a gear, a rack, a conveyor belt, a driving wheel, a sliding block, a sliding rail and the like, and may realize spatial displacement of the free end 22 relative to the fixed end 21. The displacement assembly 20 may realize change of spatial positions such as pitch, front and back, left and right, and may also realize an adjustment of a spatial angle of a central axis of the free end 22, and may arbitrarily match the above-mentioned transmission components based on a complexity of an interactive operation.

The free end 22 of each displacement assembly 20 may be provided with an end effector 30, or a plurality of end effectors 30 may be provided, and the plurality of end effectors 30 may be of the same type or different types. At the same time, the number of the displacement assemblies 20 may also be set as needed.

The end executor 30 refers to a component or apparatus with a specific function in a system, such as a grabbing tool, a laser cutting head, a camera, a sensor, a medical instrument and the like, and the end executor 30 has a capability of independently executing a specific task. The end effector 30 is coupled to the free end 22 of the displacement assembly 20, that is, the end effector 30 is tightly connected to the free end 22 of the displacement component 20 through physical or electrical manners (such as a mechanical interface, a magnetic adsorption, an electric drive and the like). When the free end 22 of the displacement assembly 20 changes in spatial position, the end effector 30 coupled thereto may also move accordingly to achieve dynamic positioning. The end effector 30 cooperates with the displacement assembly 20 to precisely adjust a position of the end effector 30 through controlling the movement of the displacement assembly 20, so that the end effector 30 can perform corresponding operations in a desired position and direction, such as actions of material grabbing, fine machining, inspection measurement and the like.

When the mobile operating robot provided by the embodiment of the present disclosure operates, the movable platform 10 may move according to a predetermined route or a dynamic planning path, and simultaneously transports the height adjustment assembly 40, the displacement assembly 20 and the end effector 30 to a specified position, and adjusts the spatial position and the spatial angle of the free end 22 of the displacement assembly 20, and may move the end effector 30 to a target position. A spatial position of the end effector 30 is precisely controlled through the displacement assembly 20, so that it can accurately complete a predetermined work task at different positions, thereby performing a physical operation or an interactive task, and may meet usage requirements of scenarios such as home or warehousing.

In some embodiments, the displacement assembly 20 includes a multi-joint operating arm, the multi-joint operating arm is formed with two opposite ends, an end of the multi-joint operating arm is the fixed end 21, and the other end of the multi-joint operating arm is the free end 22.

Referring to FIG. 1, the displacement assembly 20 includes the multi-joint operating arm, and the multi-joint operating arm is a single-arm structure which can flexibly move and can realize multi-dimensional position transformation, and is configured to perform various actions in a space. The multi-joint operating arm is formed with two opposite ends, the multi-joint operating arm extends from an end to the other end in design, no additional branch structure exists, the structure is simplified, cause space occupation may be reduced, and flexibility of the multi-joint operating arm may be also increased. An end of the multi-joint operating arm is the fixed end 21, and the fixed end 21 may be mechanically connected, supported by a bearing, or directly mounted on the height adjustment assembly 40 or other stabilizing structures on the height adjustment assembly 40. The other end of the multi-joint operating arm opposite to the fixed end 21 is the free end 22, and the free end 22 may freely move or rotate within a certain range. The free end 22 carries the end effector 30, such as a jaw, a welding head, a nozzle and the like, to complete a specific operation function.

In some embodiments, the multi-joint operating arm is a seven-joint arm, at this time, the multi-joint operating arm has seven rotary joints, and each joint allows a specific direction of freedom of movement, so that the end effector 30 can realize flexible and accurate position positioning and posture adjustment in a three-dimensional space. The seven-joint arm may perform movement and position in all directions at angles such as X, Y, Z rectangular coordinate axes and yaw, pitch, roll and the like around the three axes, thereby greatly improving a capability of adapting to various tasks, including various application scenarios such as assembling, carrying, welding, spraying, inspection, clamping, touch control and the like. It should be understood that as a complexity of the interaction task is different, fewer or more joint arms may be selected.

In some embodiments, the height adjustment assembly 40 includes a supporting part 41 and a moving part 42 for moving up and down relative to the supporting part 41, the supporting part 41 is disposed on the movable platform 10, the moving part 42 is supported by the supporting part 41 and is coupled to the fixed end 21 of the displacement assembly 20, and the moving part 42 is capable of moving up and down relative to the supporting part 41 to adjust a relative height between the displacement assembly 20 and the movable platform 10.

Referring to FIGS. 1 and 3, the height adjustment assembly 40 includes the supporting part 41 and the moving part 42, wherein the supporting part 41 refers to a basic structure that is fixed and has sufficient strength, provides a stable basic support for an entire lifting mechanism, and the moving part 42 is a part that may realize a movement in a vertical direction on the supporting part 41, and the moving part 42 may be caused to accurately move up or down relative to the supporting part 41 through a driving apparatus (such as a lead screw, an electric cylinder, a hydraulic system, a pneumatic system or a linear motor). The supporting part 41 of the height adjustment assembly 40 is connected to the movable platform 10, and the fixed end 21 is mounted on the movable part 42. When the moving part 42 moves up and down, the displacement assembly 20 fixed thereon also changes a height position.

The height adjustment assembly 40 is configured to adjust the relative height between the displacement assembly 20 and the movable platform 10, that is, the height adjustment assembly 40 flexibly adjusts the displacement assembly 20 to different heights according to actual application requirements, so as to perform various tasks more widely and flexibly in the three-dimensional space, for example, to adapt to work surfaces of different heights, to cross obstacles, or to operate on target objects of different sizes.

In some embodiments, the height adjustment assembly 40 may include two guide rails (that is, the supporting part 41) disposed in parallel and a sliding seat (that is, the moving part 42) slidably connected to the two guide rails, a vertical lead screw 43 (which may be one or more in parallel) is disposed between the two guide rails, a screw hole (correspondingly providing one or more) is disposed on the sliding seat, and the sliding seat is rotatably connected to the vertically disposed lead screw 43. As the lead screw 43 rotates, the sliding seat may move up or down along the two guide rails. The lead screw 43 is rotatably connected to the lead screw motor 44, the lead screw motor 44 is electrically connected to a lead screw controller 45, the lead screw controller 45 is electrically connected to a transformer 46 and the central control unit 91 (industrial personal computer), and based on a control signal of the central control unit 91, the lead screw 43 may be rotated clockwise or counterclockwise by a predetermined angle, thereby accurately controlling the height of the moving part 42.

In some embodiments, a photoelectric switch or another type of position sensor is disposed on the supporting part 41, and the photoelectric switch or the position sensor may generate a position signal upon detecting the moving part 42, and the controller may adjust a position and a moving speed of the moving part 42 based on the position signal.

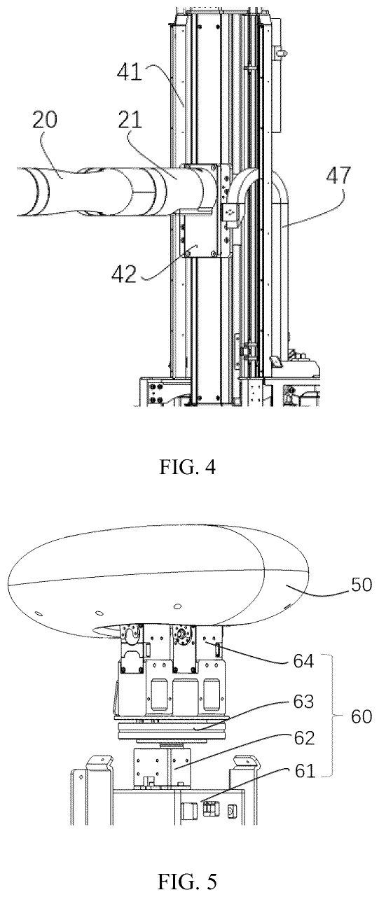

In some embodiments, referring to FIG. 1 and FIG. 4, a drag chain 47 is provided on a side of the height adjustment assembly 40, and the drag chain 47 is mainly configured to protect and manage internal lines such as various hoses, cables, wires and the like carried in a reciprocating linear motion process. On the one hand, the drag chain 47 can prevent tensile force, bending stress and external environment (such as dust, cutting fluid, mechanical collision and the like) generated during movement to damage internal cables, oil pipes, air pipes and the like, and prolong service life of these pipelines. On the other hand, the drag chain 47 makes multiple pipelines orderly arranged through a reasonable internal space design, thereby avoiding mutual winding and abrasion between the pipelines, and keeping cleanliness and safety during an operation of a device. On the other hand, the drag chain 47 has good buffering performance, can absorb vibration energy generated in a movement process, reduce noise, and ensure that the equipment runs stably, and improve stability of overall system. Finally, a structure of the drag chain 47 may be designed to be modular, and each segment may be conveniently opened and closed, facilitating replacement and adjustment of the pipelines during rapid installation and later maintenance.

In some embodiments, the mobile operating robot further includes a camera assembly 50 coupled to at least one of the movable platform 10 and the height adjustment assembly 40.

Referring to FIGS. 1-5, the camera assembly 50 is mounted on at least one of the movable platform 10 and/or the height adjustment assembly 40. Specifically, it is possible that the camera assembly 50 is directly carried on the movable platform 10 to follow the movable platform 10 to move and capture images of different positions; it is also possible to mount the camera assembly 50 on the height adjustment assembly 40, so that the camera can be moved up or down as required to obtain image information at different height views, thereby increasing a flexibility and an application range of the robot; and it is also possible to mount the camera assembly 50 at a high position on the supporting part 41 to expand a range of a field of view. A function of the camera assembly 50 in executing tasks is mainly reflected in following aspects: firstly, a camera can capture image information inside and outside various facilities such as a room and a warehouse in real time, and is configured to monitor current environment and timely discover abnormal conditions, such as fire source, smoke, leakage, structural damage, illegal invasion and the like. Secondly, through a high-definition camera technology, a patrol robot may record video data of the environment in detail to provide a basis for subsequent analysis. For example, the positioning and quantitative analysis of a corrosion condition of a water pipe wall, a crack or water seepage point of an inner wall of the tunnel and the like. Again, the camera assembly 50 combines an image processing algorithm and the SLAM (simultaneous localization and mapping) technology to help the robot perform autonomous navigation, identify road signs, obstacles and its own position in a complex environment, and ensure accurate movement to a predetermined inspection point. Again, with specific visual recognition software, the camera can recognize and track specific targets, such as instrument readings, device status indicator lights and the like, to implement automated reading and recording. In addition, the camera assembly 50 may transmit a real-time image back to a control center, so that a manager may remotely view and evaluate status of facility without a need for an in-person site, thereby improving a management efficiency and responding to an emergency event quickly. Finally, image data recorded by the camera assembly 50 may serve as an important basis for post investigation, to help analyze reasons, trace process, and provide reference for subsequent maintenance and improvement measures.

In some embodiments, the camera assembly 50 is disposed at a top of the supporting part 41, an angle adjustment assembly 60 is disposed between the supporting part 41 and the camera assembly 50, and the angle adjustment assembly 60 is configured to adjust at least one of a horizontal view angle and a pitching angle of the camera assembly 50.

Referring to FIG. 1 and FIG. 5, the camera assembly 50 is disposed at the top of the supporting part 41, at a position where the supporting part 41 is connected to the camera assembly 50, an angle adjustment assembly 60 configured to change a view angle of the camera is provided, the angle adjustment assembly 60 may be electrically or mechanically, including, for example, a stepper motor, a rotary joint, a connecting rod, or other similar apparatuses, allowing precise adjustment of an angle of the camera assembly 50, and the angle adjustment assembly 60 may be a one-dimensional or two-dimensional motion platform. The angle adjustment assembly 60 can flexibly change an angle of an observation direction of the camera, and can adjust a horizontal field angle of the camera assembly 50, that is, a left and right scan range; meanwhile, a pitch field angle, that is, an up and down tilt angles, can also be adjusted. The angle adjustment assembly 60 can realize adjustment in a single direction, can also realize simultaneous adjustment of two directions, so as to meet requirements for a monitoring range and a focusing target in different scenarios, so that the robot may adjust a pointing of the camera in real time as needed, thereby capturing an optimal image information.

In some embodiments, the angle adjustment assembly 60 is a pan-tilt structure, and at this time, the angle adjustment assembly 60 includes a pan-tilt control unit 61, a head rotating component 62, a connecting flange 63 and a head pitching component 64, the fixed end 21 of the head rotating component 62 is connected to the supporting part 41, and a rotating end of the head rotating component 62 is connected to the connecting flange 63. Under the action of the head rotating member 62, the connecting flange 63 may rotate along a vertical axis. The fixed end 21 of the head pitching component 64 is connected to the connecting flange 63, and a rotating end of the head pitching component 64 is connected to the camera assembly 50. Under the action of the head pitch component 64, the camera assembly 50 may adjust a pitch angle. Under the combined action of the head rotating part 62 and the head pitching part 64, adjustment of horizontal and pitching angles of the camera assembly 50 may be achieved.

In some embodiments, the mobile operating robot further includes a housing 70 sleeved on an outer side of the height adjustment assembly 40 and coupled to the movable platform 10. The side wall of the housing 70 is provided with an opening 71 extending vertically, the displacement assembly 20 penetrates through the opening 71, the fixed end 21 is located on an inner side of the housing 70, and the free end 22 is located outside of the housing 70.

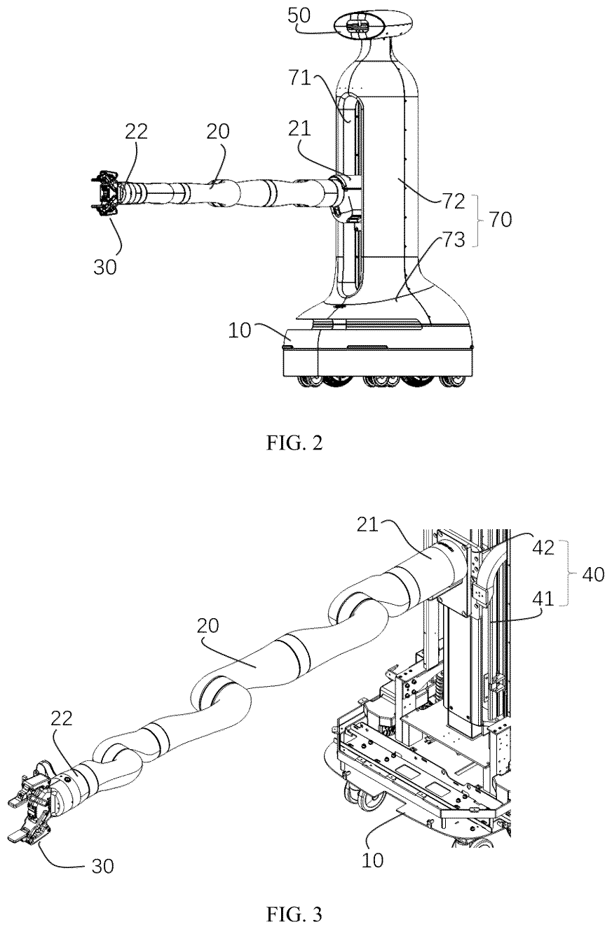

Referring to FIG. 2, in order to protect the height adjustment assembly 40 and related electrical lines and transmission mechanisms and simultaneously maintain cleanliness and safety of overall structure are maintained, the housing 70 is wrapped around the height adjustment assembly 40. The housing 70 is fixedly connected to a top of the movable platform 10 of the robot to ensure that the height adjustment assembly 40 moves synchronously with the movable platform 10 and can stably perform a height adjustment task. The opening 71 is provided in the vertical direction on one or more sides of the housing 70 (determined according to the number of the displacement assemblies 20), and the displacement assembly 20 penetrates through the opening 71 of the housing 70 and can move up and down in the vertical direction under driving of the height adjustment assembly 40. The fixed end 21 is located on an inner side of the housing 70, and the free end 22 is located on an outer side of the housing 70.

In some embodiments, the housing 70 includes a body part 72 and a base part 73 located below the body part 72, a cross-sectional area of the body part 72 in the horizontal direction is adapted to a cross-sectional area of the height adjustment assembly 40 in the horizontal direction, the body part 72 is connected to the base part 73, and the base part 73 is connected to a top edge of the movable platform 10.

Referring to FIG. 2, the housing 70 is divided into the body part 72 and the base part 73 in the vertical direction, the body part 72 refers to a main part of the housing 70 for accommodating, supporting or protecting the internal height adjustment assembly 40, and the base part 73 serves as a basic part of a structure of the entire housing 70. A size of the body part 72 of the housing 70 on a horizontal plane is designed to exactly wrap the height adjustment assembly 40, so that the two are tightly combined in cross section, which not only hinders a normal operation of the height adjustment assembly 40, but also provides a good protection effect for the height adjustment assembly 40, so that a structure and a size of the robot may be simplified. A transition between the body part 72 and the base part 73 of the housing 70 is continuous and has no obvious steps or abrupt changes, which helps to improve the stability of the overall structure, reduce stress concentration points, and exert an effect of optimizing appearance. The base part 73 and the top edge of the movable platform 10 are smoothly connected, there is no obvious gap or discontinuity between them, thereby ensuring an integration degree of the overall structure and a coordination between the components during a movement, and also helping to reduce noise and vibration and improve the stability and a durability of an operation of the system. At the same time, the smoothly connected structure does not exist or exist less corners, so that scratch of users and children in a home scene may be avoided.

In some embodiments, the movable platform 10 is provided with a counterweight component 80, wherein the counterweight component 80 is configured to balance a bending torque when the displacement assembly 20 and the end effector 30 extend out.

Referring to FIG. 1, the counterweight component 80 is a weight module mounted on the movable platform 10 for balancing a center of gravity distribution of entire robot, ensuring that when the displacement assembly 20 and the end effector 30 perform an action, especially when they extend (such as extend, expand, or rotate) from the body of the movable platform 10, instability or overturning of the movable platform 10 is not caused by a change of torque.

When the displacement assembly 20 and the end effector 30 operate, particularly when they extend outwardly away from a center point of the movable platform 10, a torque may be created that causes the platform to flip or tilt. The counterweight component 80 generates a torque in an opposite direction through its own weight and arrangement position, so as to effectively counteract an imbalance effect caused by extension of component, and ensure that the platform can maintain stable and safe operating states in an entire working range.

In some embodiments, the movable platform 10 is further provided with a balance adjustment apparatus, the weight component 80 is mounted on the balance adjustment apparatus, the balance adjustment apparatus is electrically connected to the industrial personal computer of the robot, and the balance adjustment apparatus may adjust a relative position of the balance weight component 80 on the movable platform 10.

When a specification and a model of the end effector 30 are determined, its weight may also be determined. When the end effector 30 is a clamper, the weight of a clamped object may be calculated reversely according to a clamping force.

An extension distance of the end effector 30 relative to the center of the movable platform 10 may be obtained according to an extended state parameter of the displacement assembly 20.

According to the weight of the end effector 30, the clamping weight acquired by a sensor on the end effector 30, and the above-mentioned extension distance, a lateral bending torque experienced by the robot at this time may be calculated reversely.

A balance distance required to be adjusted by the counterweight component 80 may be determined according to the lateral bending torque and a predetermined balance relationship. The controller generates a balance control signal according to the balance distance, and sends the balance control signal to the balance adjustment apparatus. After receiving the balance control signal, the balance adjustment apparatus starts to operate, adjusts the weight component 80 to the other side of the top of the movable platform 10 away from the displacement assembly 20, at this time, a distance between the balance weight component 80 and a center of the movable platform 10 is greater than or equal to the balance distance, or a difference between the distance between the weight component 80 and the center of the movable platform 10 and the balance distance meets a predetermined security relationship.

As may be seen from the above-mentioned, neither a lateral overturning nor instability of a displacement operating robot may be caused when the end effector 30 moves or performs an action in a space, and the safety is high.

In this embodiment, when a heavy end effector 30 or the end effector 30 is mounted to bear a large load, the size of the movable platform 10 does not need to be increased, the structure of the displacement operating robot may be kept light and flexible, and the application range is wider.

In some embodiments, the fixed end 21 of the displacement assembly is detachably connected to the movable platform 10. Referring to FIG. 1, the fixed end 21 of the displacement assembly is detachably connected to the movable platform 10, that is, the fixed end 21 of the displacement assembly may be connected through a screw, a buckle, a bolt or other connection manners convenient to mount and detach. At this time, the user is allowed to easily remove an original displacement assembly from the movable platform 10 according to an actual application scenario or requirement change, and replace the displacement assembly with different specifications or functions. When a working task changes or needs to adapt to a new working environment, an operator may quickly replace the displacement assembly suitable for a current task requirement, thereby improving the flexibility and adaptability of the robot, reducing an overall ownership cost and improving a working efficiency.

In some embodiments, the end effector 30 is detachably connected to the free end 22 of the displacement assembly 20. Referring to FIG. 1, in the displacement operating robot, the end effector 30 is detachably connected to the free end 22 of the displacement assembly 20. When designing, a modular and high-flexibility interface manner is adopted, so that the end effector 30 may be conveniently and quickly mounted or detached from the displacement assembly 20 according to actual operation requirements, and replaced with other types of end effectors 30. For example, when an object of different shapes and sizes needs to be grabbed, an original clamping type end effector 30 may be quickly replaced with a sucker type or pincer end effector 30.

Due to interchangeability of the end-effector 30, the robot has higher adaptability and versatility when facing different task scenarios. For example, the robot originally used for carrying materials may be converted into other work such as welding, spraying or precision assembly after simply replacing the end effector 30, thereby significantly improving a service capability and overall operation performance of the robot.

In the mobile operating robot provided by the embodiments of the present disclosure, electrical components such as the movable platform 10, the height adjustment component 40, the angle adjustment component 60, the camera assembly 50, the displacement assembly 20, and the end execution part 30 exist, in order to realize precise control of each electrical component, the mobile operating robot further includes electronic control components such as a central control unit 91 (an industrial personal computer), a voltage converter 92, a delay power-on module, the motor driver and the controller, and the electrical component is electrically connected to the corresponding electronic control component. Displacement control of the movable platform 10, spatial displacement (stretching and folding) of the displacement assembly 20, action execution of the end effector 30, image acquisition of the camera assembly 50, movement of up and down of the height adjustment assembly 40, and angle control of the angle adjustment assembly 60 are achieved under the action of the electrical signal. The mobile operating robot further includes an intelligent sensing unit 93, such as an inertial measurement unit (IMU), an odometer, a GPS, a visual navigation system and the like, and is configured to acquire robot position and posture information in real time, and control autonomous navigation and obstacle avoidance of the robot through an advanced motion planning algorithm.

In order to make a structure of the mobile operating robot more simplified, the embodiments of the present disclosure may integrate the industrial personal computer, a voltage reduction module, the delay power-on module, the motor driver, the controller and other electronic control elements together, and reduce a space occupation as much as possible on a premise of reserving a necessary heat dissipation and ventilation functions.

In some cases, there is one displacement assembly 20, at this time, the movement operating robot is a single-arm movement operating robot, and at this time, an electric control element such as the industrial personal computer, the voltage reduction module, the delay power-on module, the motor driver and the controller may be integrated on a side of the height adjustment assembly 40 away from the displacement assembly 20.

Various embodiments of the present disclosure have been described above, which are exemplary, not exhaustive, and are not limited to the embodiments disclosed. Many modifications and variations will be apparent to those of ordinary skill in the art without departing from a scope and spirit of the illustrated embodiments. Selection of terms used herein is intended to best explain principles of the embodiments, practical applications, or technical improvements in marketplace, or to enable others of ordinary skill in the art to understand the embodiments disclosed herein.

I/we claim:

1. A mobile operating robot, comprising:
a movable platform;
a height adjustment assembly disposed on the movable platform;
a displacement assembly comprising a fixed end and a free end, wherein the fixed end is coupled to the height adjustment assembly to move with the height adjustment assembly, and the free end is capable of performing spatial displacement relative to the fixed end; and
an end effector coupled to the free end of the displacement assembly for performing a predetermined operation.

2. The mobile operating robot of claim 1, wherein the displacement assembly comprises:
a multi-joint operating arm comprising two opposite ends, an end of the multi-joint operating arm is the fixed end, and the other end of the multi-joint operating arm is the free end.

3. The mobile operating robot of claim 1, wherein the height adjustment assembly comprises:
a supporting part disposed on the movable platform; and
a moving part supported by the supporting part and coupled to the fixed end of the displacement assembly, wherein the moving part is capable of moving up and down relative to the supporting part to adjust a relative height between the displacement assembly and the movable platform.

4. The mobile operating robot of claim 3, further comprising:
a camera assembly coupled to at least one of the movable platform and the height adjustment assembly.

5. The mobile operating robot of claim 4, further comprising:
an angle adjustment assembly disposed at a top of the supporting part and coupled to the camera assembly, wherein the angle adjustment assembly is configured to adjust at least one of a horizontal view angle and a pitching view angle of the camera assembly.

6. The mobile operating robot of claim 3, further comprising:
a housing sleeved on an outer side of the height adjustment assembly and coupled to the movable platform; wherein a side wall of the housing is provided with an opening extending vertically, the displacement assembly penetrates through the opening, the fixed end is located on an inner side of the housing, and the free end is located on an outer side of the housing.

7. The mobile operating robot of claim 6, wherein the housing comprises a body part and a base part located below the body part, a cross-sectional area of the body part in a horizontal direction is adapted to a cross-sectional area of the height adjustment assembly in the horizontal direction, the body part is connected to the base part, and the base part is connected to a top edge of the movable platform.

8. The mobile operating robot of claim 1, further comprising:
a counterweight component disposed on the movable platform, wherein the counterweight component is configured to balance a bending torque when the displacement assembly and the end effector extend out.

9. The mobile operating robot of claim 1, wherein the fixed end of the displacement assembly is detachably connected to the height adjustment assembly.

10. The mobile operating robot of claim 1, wherein the end effector is detachably connected to the free end of the displacement assembly.

11. The mobile operating robot of claim 1, wherein the movable platform comprises a two-wheel differential chassis.
